(19) United States
(12) Patent Application Publication
(10) Pub. No.: US 2007/0011214 A1
(43) Pub. Date: Jan. 11, 2007

(54) Oject level adaptive allocation technique

(76) Inventor: Venkateswararao Jujjuri, Beaverton, OR (US)

Correspondence Address: LIEBERMAN & BRANDSDORFER, LLC, 802 STILL CREEK LANE, GAITHERSBURG, MD, 20878, US

(21) Appl. No.: 11/175,646

(22) Filed: Jul. 6, 2005

(51) Int. Cl. G06F 17/30

(52) U.S. Cl. 707/205

(57) ABSTRACT

A variable known as an allocation coefficient is assigned to a file for use in calculating the maximum number of blocks to be allocated in response to a block allocation request. The allocation coefficient may be adjusted in response to each individual request to reflect the current state of block consumption on an object. Similarly, the allocation coefficient may be adjusted in response to a synchronization transaction based upon the usage of requested blocks for past write operations. In response to either situation, the allocation coefficient is adaptable to reflect an increase or a decrease in block consumption and to more accurately allocate blocks for a write operation in response to characteristics of prior operations.

### BACKGROUND OF THE INVENTION

1. Technical Field

This invention relates to efficiently allocating data blocks in response to an allocation request to satisfy a write operation. More specifically, a technique is provided to dynamically adjust the amount of blocks allocated to satisfy the request by taking into consideration characteristics of both a current allocation request and block consumption history.

2. Description of the Prior Art

FIG. 1 is a prior art block diagram (10) of a distributed file system including a server cluster (20), a plurality of client machines (12), (14), and (16), and a storage area network (SAN) (30). Each of the client machines communicates with one or more server machines (22), (24), and (26) over a data network (40). Similarly, each of the client machines (12), (14), and (16) and each of the server machines in the server cluster (20) are in communication with the storage area network (30). The storage area network (30) includes a plurality of shared disks (32) and (34) that contain only blocks of data for associated files. Similarly, the server machines (22), (24), and (26) contain only metadata pertaining to location and attributes of the associated files. Each of the client machines may access an object or multiple objects stored on the file data space of the SAN (30), but may not access the metadata space. In opening the contents of an existing file object on the storage media in the SAN (30), a client machine contacts one of the server machines to obtain metadata and locks. Metadata supplies the client with information about a file, such as its attributes and location on storage devices. Locks supply the client with privileges it needs to open a file and read or write data. The server machine performs a look-up of metadata information for the requested file within metadata space of the SAN (30). The server machine communicates granted lock information and file metadata to the requesting client machine, including the location of all data blocks making up the file. Once the client machine holds a lock and knows the data block location(s), the client machine can access the data for the file directly from a shared storage device attached to the SAN (30).

As shown in FIG. 1, the illustrated distributed file system separately stores metadata and data. Metadata, including the location of blocks of each file on shared storage, are maintained on high performance storage at the server machines (22), (24), and (26). The shared disks (32) and (34) contain only blocks of data for the files. This distribution of metadata and data enables optimization of data traffic on the shared disks (32) and (34) of the SAN (30), and optimization of the metadata workload. One method for block allocation for writing to an object in conjunction with the system of FIG. 1 is known as an on demand allocation. This method supports the client asking the server for a required number of blocks to satisfy the write request. In response to the client request, the server grants the client the requested number of blocks to write to the object, if the blocks are available. The demand allocation method is primitive in nature because it is limited to satisfying a particular write operation instead of intelligently requesting additional blocks to avoid future server transactions. Accordingly, the on demand allocation may result in an increase in network traffic associated with additional allocation requests.

Another method for data allocation for writing to an object in conjunction with the system of FIG. 1 is known as an aggressive allocation. This method also supports the client asking the server for a required number of blocks to satisfy the write request. However, in response to the request, the server allocates more blocks than requested by the client to satisfy the write request, if the blocks are available. One advantage of the aggressive allocation technique is that it reduces the number of requests that the client has to make to the server to satisfy future write operations, thus reducing network traffic. However, the disadvantage of the aggressive allocation technique is the potential for in-efficient use of the disk. Both the demand allocation and the aggressive allocation techniques have limitations in accurately allocating an appropriate number of blocks for client consumption. Accordingly, the prior art techniques result in either an increase in network traffic or wastage of disk space, or both.

There are other techniques available where a client estimates block consumption for a write operation, and factors that into a request to the server for a block allocation. However, this method does not solve the problem of reclaiming unused disk space for the blocks that remain unused following completion of the write operation, resulting in in-efficient disk usage.

Therefore, there is a need for a technique that determines an accurate allocation of blocks of data for each write operation. Such a technique should also support the advantages provided from both the demand and aggressive allocation techniques, while reducing network traffic, the number of client-server transactions, and mitigating wastage of disk space.

### SUMMARY OF THE INVENTION

This invention comprises a method and system for efficiently managing objects in a file system of a client-server computer system.

In one aspect of the invention a method is provided for managing objects in a file system. A dynamically adjustable allocation coefficient is assigned to each object in the file system. The allocation coefficient identifies a block consumption rate. The allocation coefficient is adjusted in response to a change in the block consumption rate. A prediction is conducted of a quantity of blocks to be allocated from a server by factoring in both a quantity of client requested blocks and the allocation coefficient.

In another aspect of the invention, a computer system is provided with a file system having a plurality of managed objects. A dynamically adjustable allocation coefficient is assigned to each of the objects to identify a block consumption rate, and a coefficient manager is provided to adjust the allocation coefficient in response to a change in the block consumption rate. In addition, a prediction manager is provided to determine a quantity of blocks of an object to be allocated from a server to a client. The prediction is responsive to an amount of client requested blocks and the allocation coefficient.

In yet another aspect of the invention, an article is provided with a computer-readable signal bearing medium. Means in the medium are provided for assigning a dynamically adjustable allocation coefficient to each object. The allocation coefficient is associated with a block consumption rate. In addition, means in the medium are provided for dynamically adjusting the allocation coefficient in response to a change in the block consumption rate, and means in the medium are provided to predicting a quantity of blocks to be allocated from a server in response to an amount of blocks requested by a client and the allocation coefficient.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a prior art distributed file system.

FIGS. 2a and 2b are flow charts illustrating adjustment of the allocation coefficient in conjunction with processing of a block allocation request according to the preferred embodiment of this invention, and are suggested for printing on the first page of the issued patent.

FIG. 3 is a flow chart illustrating adjustment of the allocation coefficient during a synchronization transaction.

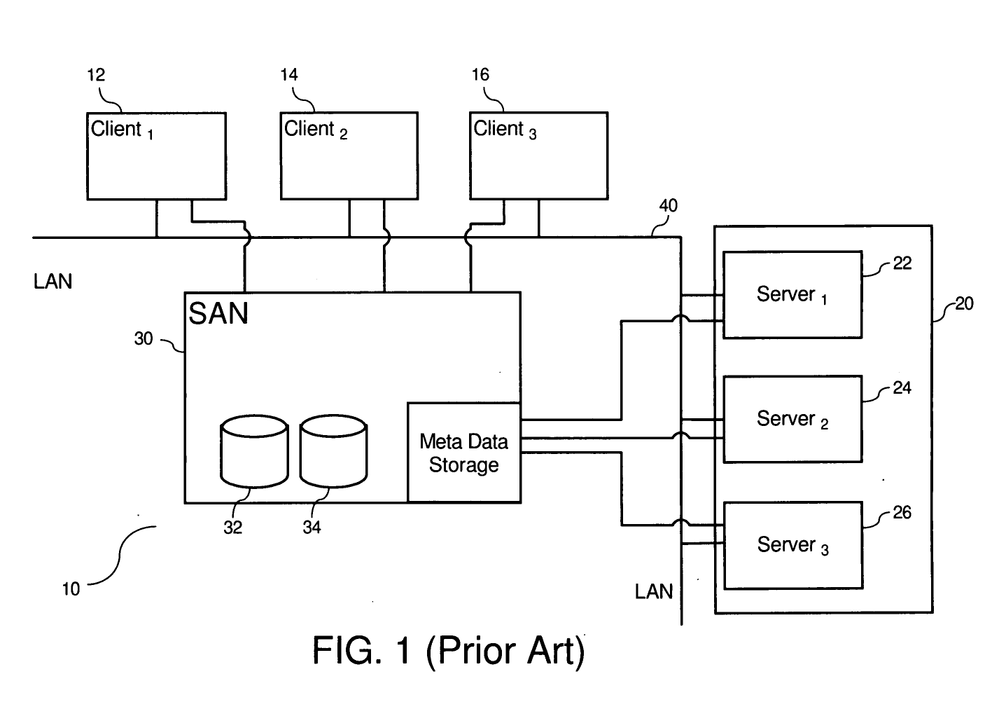

### DESCRIPTION OF THE PREFERRED EMBODIMENT

### Overview

An allocation coefficient is a variable based upon a quantity of blocks used during a block allocation request to satisfy a write operation. The allocation coefficient may be adjusted in response to a block allocation request, as well as in response to a synchronization transaction. In a block allocation request, the allocation coefficient is adjusted based on a function of a percentage of blocks allocated and used in a prior allocation request. Similarly, in a synchronization transaction, the allocation coefficient is adjusted based on a function of unused blocks remaining after completion of one or more transactions. Accordingly, the allocation coefficient is examined and adjusted for each allocation request and synchronization transaction.

### Technical Details

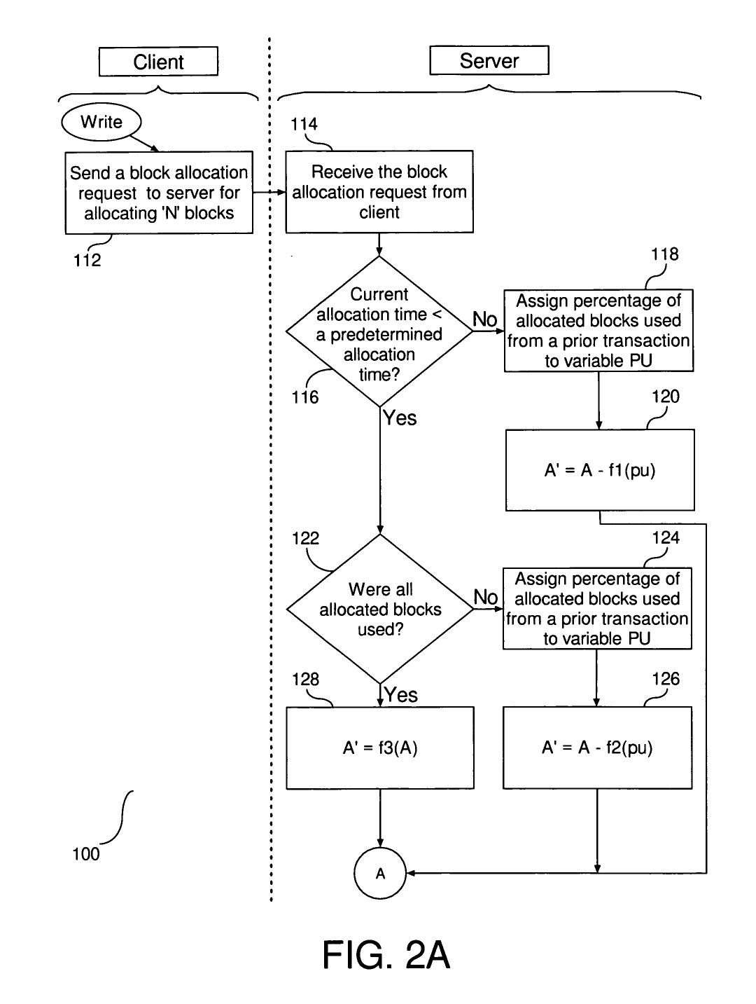

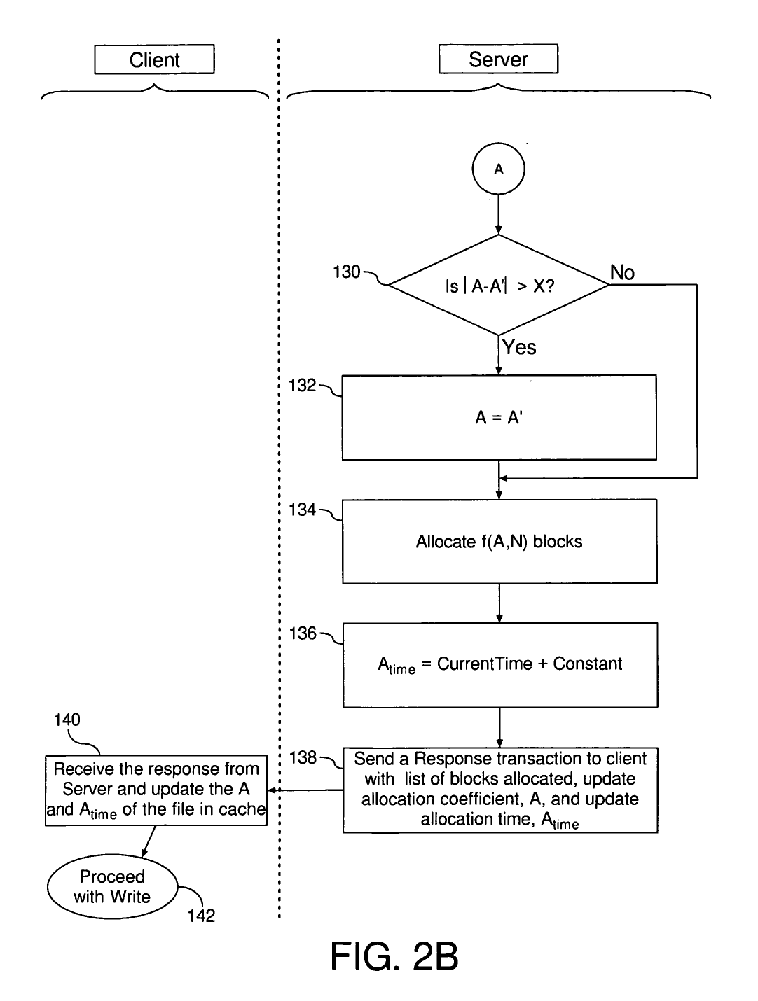

FIG. 2 is a flow chart (100) demonstrating a process for adaptively adjusting the allocation coefficient in a client-server computer system in conjunction with a write operation resulting in a block allocation request from a client to a server. On the client machine, an application calls a corresponding operating system write service. In one embodiment the write operation may be in the form of a system call. The write operation requests that it needs N number of blocks to satisfy the write request. The client sends a block allocation request to the server requesting a quantity of blocks, N, for the transaction (112). In response to receipt of the block allocation request (114), the server conducts a test to determine if the current allocation time is less than or equal to a predetermined allocation time (116). The allocation time represents the time of the last block allocation conducted for this file by the server plus a constant. The test at step (116) is used to determine the frequency of block allocation requests received by the server. A negative response to the test at step (116) is an indication the requests are infrequent and will result in assigning a percentage of allocated blocks used from a prior transaction to a variable PU (118). In addition, a temporary allocation coefficient, A′, is assigned to the difference of the allocation coefficient, A, less a function, f₁, of the percentage of allocated blocks used (120). The allocation coefficient A begins as a constant and is dynamically adjusted thereafter. A positive response to the test at step (116) is an indication that the requests are frequent and will result in a subsequent test to determine if all of the blocks allocated by the server in the prior block allocation were used (122). A negative response to the test at step (122) will result in assigning a percentage of allocated blocks used to a variable, PU, (124) and assigning a temporary allocation coefficient, A′, to the difference of the current allocation coefficient, A, less a function, f₂, of the percentage of allocated blocks used (126). However, a positive response to the test at step (122) will result in assigning a temporary allocation coefficient, A′, to a function, f₃, of the current allocation coefficient, A (128). The function, f₃, assigned to the temporary allocation coefficient, A′, at step (128) is an exponential function, and the functions, f₁ and f₂, assigned at steps (120) and (126), respectively, are linear functions. Another important factor to note is, A′ in steps (120) and (126) has a reduced value compared to A, indicating that server may be less aggressive with block allocation. However, at step (128) the A′ is increased, indicating the server needs to be more aggressive in allocating blocks. It should be noted that although the functions f₁ and f₂ relate to the percentage of allocated blocks used, both of these functions have different values for the PU assigned at steps (118) or (124). Accordingly, the first step in adjusting the allocation coefficient during an allocation includes determining the frequency of write requests received by the server and assigning a temporary allocation coefficient based on the results of the frequency test.

Following assignment of a temporary allocation coefficient, A′, a test is conducted to determine if the absolute value of the difference between the temporary allocation coefficient and the actual allocation coefficient is greater than a pre-assigned constant, X, (130). The test at step (130) indicates whether the allocation coefficient should be changed in view of the value of the temporary allocation coefficient. A positive response to the test at step (130) will result in changing the allocation coefficient to the value assigned the temporary allocation coefficient (132). Following step (132) or a negative response at step (130), a set of blocks are allocated (134) based upon a function of the requested amount from step (112) and the new value of the allocation coefficient from step (132). Following the block allocation, an update is conducted of the allocation time. The new allocation time, Aₜᵢₘₑ, is set as the sum of the current system time and a predetermined constant (136). After completion of step (136), a response is sent from the server to the client with a list of blocks allocated, an updated allocation coefficient, and an updated allocation time (138). Upon receipt of the response from the server, the client updates the allocation coefficient and allocation time in the client cache (140) and proceeds with the write operation (142). The allocation coefficient and allocation time values may be stored in the client cache, or server cache or, optionally in a data structure accessible by both the client and server. Accordingly, based upon the difference between the actual allocation coefficient and the temporary allocation coefficient assigned in response to a block allocation request, the actual allocation coefficient may be changed or it may remain constant with the value being returned to the client in conjunction with a block allocation.

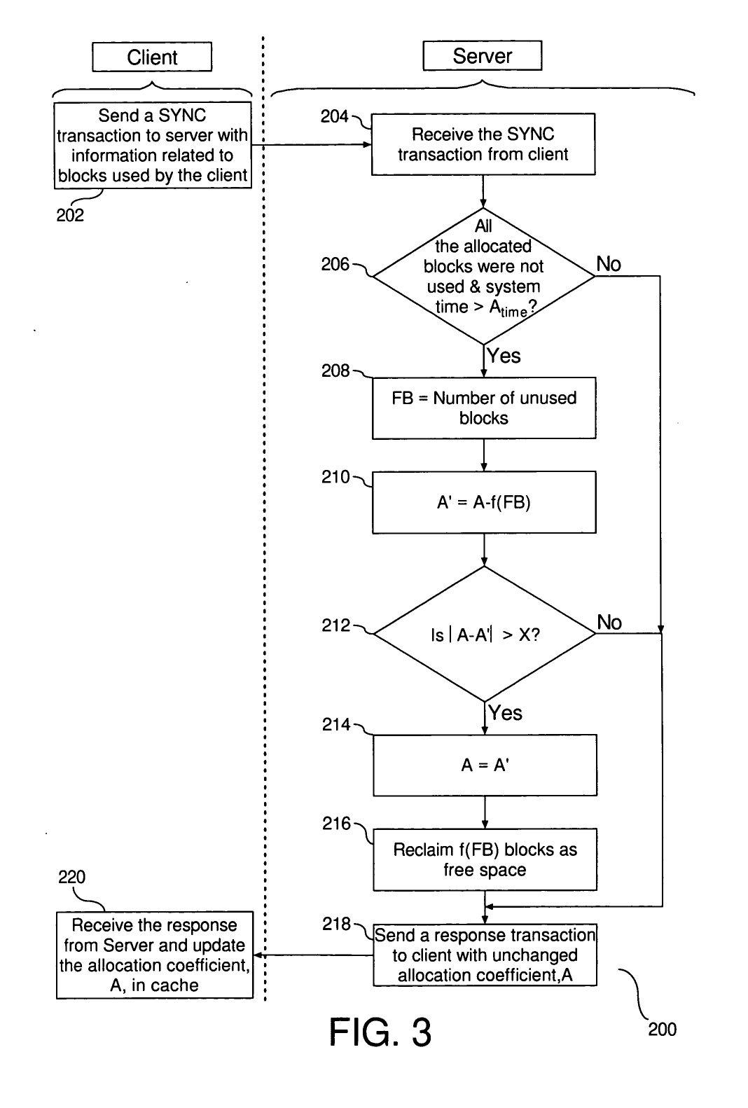

As shown in FIG. 2, the allocation coefficient may be adjusted in response to an allocation request for a set of blocks by a client. In addition, the allocation coefficient may be adjusted during a synchronization transaction when the client cache is updated with the server to provide a current state of metadata and file data. FIG. 3 is a flow chart (200) illustrating a process for adjusting the allocation coefficient during synchronization. As shown, during the synchronization transaction, the client sends a communication to the server with information related to blocks used by the client (202). Upon receipt of the transaction by server (204), the server conducts a test to determine whether all of the allocated blocks were not used and whether the system time is greater than the allocation time (206). If the response to the test at step (206) is positive, the number of unused block is set to a variable FB (208). Thereafter, a temporary allocation coefficient variable, A′, is assigned a value of the difference between the allocation coefficient, A, and a function of the unused block variable, FB, (210) set at step (208). Following step (210), a further test is conducted to determine if the absolute value of the difference between the old allocation coefficient variable, A, and the new temporary allocation coefficient variable, A′, is greater than a set constant (212). A positive response to the test at step (212) will result in setting the new allocation coefficient variable, A, to the value of the temporary allocation coefficient variable, A′, (214), and reclaiming the function of the unused block variable, FB, as free space (216). In one embodiment, the function of the FB variable may be an exponential function. However, following step (216) or if the response to the tests at step (206) or (212) is negative, a communication is sent from the server to the client with the unchanged allocation coefficient, A (218). Upon receipt of the updated allocation time variable, the client updates the allocation coefficient in the client cache (220). The allocation coefficient and allocation time values may be stored in the client cache, server cache, or in a data structure accessible by both the client and server. Accordingly, during a synchronization transaction, the allocation coefficient may be adjusted based upon a function associated with a quantity of unused blocks.

As shown in FIGS. 2 and 3, an allocation coefficient may be changed to predict current block consumption based upon one or many prior transactions. In one embodiment, the determination of the quantity of blocks to be allocation from a server to a client may be in the form of a prediction manager, which in itself is responsive to blocks in a client request and the allocation coefficient. In addition, a dynamic adjuster is provided to change the allocation coefficient in response to a change in the block consumption rate. For example, the dynamic adjuster may reduce a block allocation if the coefficient changes below a set threshold. Similarly, the dynamic adjuster may increase a block allocation if the coefficient changes above a set threshold. In one embodiment, the invention can take the form of a hardware embodiment, a software embodiment, or an embodiment containing both hardware and software elements. In a preferred embodiment, the invention is implemented in software, which includes but is not limited to firmware, resident software, microcode, etc. The software implementation can take the form of a computer program product accessible from a computer-useable or computer-readable medium providing program code for use by or in connection with a computer or any instruction execution system. For the purposes of this description, a computer-useable or computer-readable medium can be any apparatus that can contain, store, communicate, propagate, or transport the program for use by or in connection with the instruction execution system, apparatus, or device.

### Advantages Over The Prior Art

An allocation coefficient is provided to reflect allocation of blocks during a block allocation request between a client and a server. The allocation coefficient is evaluated, and, if necessary, adjusted during an allocation request. Similarly, the allocation coefficient is evaluated, and, if necessary adjusted during a synchronization transaction between a client and a server. The adjustment to the allocation coefficient, if any, is dynamic as it may occur at various times to reflect the current state of block allocation. The adaptability of the allocation coefficient contributes to the efficient allocation of blocks. By assigning an allocation coefficient and dynamically evaluating an adjustment for each individual transaction, and also by reclaiming unused blocks during a synchronization transaction, the server can now allocate an accurate quantity of blocks for a write transaction. This mitigates wasted space and network traffic encountered in the prior art solutions.

### Alternative Embodiments

It will be appreciated that, although specific embodiments of the invention have been described herein for purposes of illustration, various modifications may be made without departing from the spirit and scope of the invention. In particular, each file which is receiving data from a write transaction network may have its own allocation coefficient. Additionally, the system may be a distributed file system, or any system in which one machine issues a request to another machine for blocks of an object for a write operation resulting in an allocation request. Accordingly, the scope of protection of this invention is limited only by the following claims and their equivalents.

I claim:

1. A method for managing objects in a file system comprising:
assigning a dynamically adjustable allocation coefficient to each object, said allocation coefficient identifying a block consumption rate;
adjusting said allocation coefficient in response to a change in said block consumption rate; and
predicting a quantity of blocks to be allocated from a server in based on a quantity of blocks of a client request and said adjustable allocation coefficient.

2. The method of claim 1, wherein said dynamic adjustment includes reducing a block allocation in response to a decrease of said coefficient below a threshold.

3. The method of claim 1, wherein said dynamic adjustment includes increasing a block allocation in response to an increase of said coefficient above said threshold.

4. The method of claim 1, further comprising said server reclaiming unused blocks during a synchronization transaction with said client.

5. The method of claim 5, further comprising adjusting said allocation coefficient to reflect said unused block reclamation.

6. A computer system comprising:
a file system with a plurality of managed objects;
a dynamically adjustable allocation coefficient assigned to each of said objects to identify a block consumption rate;
a coefficient manager adapted to adjust said allocation coefficient responsive to a change in said block consumption rate; and
a prediction manager adapted to determine a quantity of blocks of an object to be allocated from a server, said prediction manager is responsive to a quantity of blocks in a client request and said allocation coefficient.

7. The system of claim 6, further comprising a dynamic adjuster adapted to change said allocation coefficient responsive to a change in said block consumption rate.

8. The system of claim 7, wherein said dynamic adjuster is adapted to reduce a block allocation responsive to a change of said coefficient below a threshold.

9. The system of claim 7, wherein said dynamic adjuster is adapted to increase a block allocation responsive to a change of said coefficient above a threshold.

10. The system of claim 6, further comprising a reclamation manager adapted to gather unused blocks through a synchronization transaction with said client.

11. The system of claim 10, wherein said reclamation manager is adapted to adjust said allocation coefficient to reflect said unused block reclamation.

12. An article comprising:
a computer-readable signal bearing medium;
means in the medium for assigning a dynamically adjustable allocation coefficient to each object, wherein said allocation coefficient is associated with a block consumption rate;
means in the medium for dynamically adjusting said allocation coefficient in response to a change in said block consumption rate; and
means in the medium for predicting a quantity of blocks to be allocated from a server in response to a client requested amount of blocks and said allocation coefficient.

13. The article of claim 12, wherein said medium is selected from a group consisting of: a recordable data storage medium, and a modulated carrier signal.

14. The article claim 12, wherein said dynamic adjustment means includes means for reducing a block allocation in response to a decrease of said coefficient below a threshold.

15. The article of claim 12, wherein said dynamic adjustment means includes means for increasing a block allocation in response to an increase of said coefficient above said threshold.

16. The article of claim 12, further comprising means for supporting said server reclaiming unused blocks during a synchronization transaction with said client.

17. The article of claim 16, further comprising means for adjusting said allocation coefficient to reflect said unused block reclamation.
